(19) United States
(12) Patent Application Publication
(10) Pub. No.: US 2011/0091257 A1
(43) Pub. Date: Apr. 21, 2011

(54) SHEET SUPERPOSING DEVICE AND IMAGE FORMING SYSTEM

(75) Inventor: Yasushi SAITSU, Hachioji-shi (JP)

(73) Assignee: Konica Minolta Business Technologies, Inc., Tokyo (JP)

(21) Appl. No.: 12/894,661

(22) Filed: Sep. 30, 2010

(30) Foreign Application Priority Data
Oct. 16, 2009 (JP) 2009-238915

(51) Int. Cl. G03G 15/00; B65H 39/00

(52) U.S. Cl. 399/403; 270/58.01

(57) ABSTRACT

A sheet superposing device to superpose sheets supplied from an image forming device, and eject the superposed sheets to a finishing device following the sheet superposing device, the sheet superposing device including: a control section to obtain sheet structure information indicating a structure of sheets of a set, the set on which finishing is performed; judge whether or not a number of the sheets of the set is two or more based on the obtained sheet structure information; and superpose two sheets or more of the sheets of the set when the number of the sheets of the set is two or more.

### BACKGROUND OF THE INVENTION

1. Field of the Invention

The present invention relates to a sheet superposing device and an image forming system.

2. Description of the Related Art

Conventionally, an image forming system composed of an image forming device, a sheet superposing device, and a finishing device is used.

The sheet superposing device superposes sheets (sheet superposing, hereinafter), the sheets which are supplied from the image forming device, and ejects the superposed sheets to the finishing device. This operation thereof makes up for the difference in sheet carry speed between the image forming device and the finishing device, and allows the finishing device to secure a finishing time which is necessary for the finishing device to perform finishing on the sheets. Consequently, a jam can be prevented from occurring.

For example, the finishing device has processing ability to receive sheets 100 times/min, the image forming device has processing ability to eject a sheet 120 times/min, and sheets are directly supplied from the image forming device to the finishing device without being superposed. In this case, a jam occurs because there is difference in processing ability (sheet carry speed) between the image forming device and the finishing device, and/or because finishing ability of the finishing device is not fast enough.

However, for example, when two sheets are superposed by the sheet superposing device, the sheet superposing device ejects the superposed sheets 60 times/min (120 divided by 2 gives 60). Consequently, the finishing device performs a sheet receiving operation 60 times/min. Since performing the sheet receiving operation 60 times/min is within the range of the processing ability of the finishing device, a jam does not occur. That is, a jam can be prevented from occurring by sheet superposing.

As an example of technology by which sheets are superposed, there is known a technology by which it is judged whether all the sheets of a set or the first and second sheets of a set are the same size or not, and when it is judged that all the sheets of the set or the first and second sheets of the set are the same size, all the sheets of the next set or the first and second sheets of the next set are superposed, as disclosed in Japanese Patent Application Laid-open Publication No. 2001-158564.

As another example of the technology, there is known a technology to perform processing, the processing by which whether sheets are superposed or not is judged on a sheet-by-sheet basis, as disclosed in Japanese Patent Application Laid-open Publication No. 2008-187592.

### SUMMARY OF THE INVENTION

However, the above-mentioned patent documents do not disclose a technology by which sheets are superposed based on sheet structure information. As a result, a problem arises that productivity (of an image forming system from image forming to finishing) decreases. The sheet structure information is information on a structure of sheets in a set (which is a unit on which finishing is performed). Hereinafter, the sheet structure information is referred to as set sheet structure information. More specifically, the set sheet structure information indicates sheet information (information on a sheet such as a paper type of a sheet) on sheets which consist of a set. For example, when the first set is composed of five sheets, set sheet structure information is composed of sheet information on the five sheets. In this case, the set sheet structure information includes information that the number of sheets in the set is five.

Referring to FIGS. 13A and 13B, the processing by which whether sheets are superposed or not is judged on a sheet-by-sheet basis (sheet-basis superposing judgment processing, hereinafter), which is an example of the conventional technology by which sheets are superposed, and processing by which it is judged whether sheets are superposed or not based on set sheet structure information (set sheet structure information-based superposing judgment processing, hereinafter) are described. FIG. 13A shows the sheet-basis superposing judgment processing. FIG. 13B shows the set sheet structure information-based superposing judgment processing. A standard sheet ejection interval shown in FIGS. 13A and 13B indicates an interval between ejection of a sheet and ejection of another sheet from an image forming device to a sheet superposing device. Numeral values shown in FIGS. 13A and 13B indicate sheet numbers, respectively. It is necessary for a finishing device to secure time which is twice (two standard sheet ejection intervals) as long as the standard sheet ejection interval as a sheet reception interval which is an interval between reception of a sheet/sheets and reception of another sheet/other sheets from the sheet superposing device. In the processing shown in FIG. 13A and the processing shown in FIG. 13B, the number of sheets in a set is five, and sheet conditions (a condition of a sheet such as a paper type of a sheet) of the five sheets are the same.

The processing, which are shown in FIGS. 13A and 13B, as of the time when sheet information on the fourth sheet is sent from the image forming device to the sheet superposing device are described. The processing shown in FIG. 13A is the sheet-basis superposing judgment processing, and the sheet superposing device cannot recognize sheet information (paper type of a sheet and the like) on the fifth sheet at the time when the sheet information on the fourth sheet is sent from the image forming device. Hence, the sheet superposing device has no choice but to superpose two sheets which are the third and fourth sheets (shown in FIG. 13A(1)). The finishing device needs to secure two standard sheet ejection intervals as the sheet reception interval. Therefore, the sheet superposing device needs to delay ejecting the fifth sheet for a one-sheet period (one standard sheet ejection interval) (shown in FIG. 13A(2)). Accordingly, it is necessary for the image forming device to delay ejecting the first sheet of the next set to the sheet superposing device for a one-sheet period (shown in FIG. 13A(3)).

On the other hand, the processing shown in FIG. 13B is the set sheet structure information-based superposing judgment processing, and the sheet superposing device recognizes set sheet structure information on the first set (sheet information on the first to fifth sheets). Hence, the sheet superposing device can recognize sheet information on the fifth sheet at the time when sheet information on the fourth sheet is sent from the image forming device. Therefore, the third, fourth, and fifth sheets can be superposed (shown in FIG. 13B(4)). Consequently, as compared with the sheet-basis superposing judgment processing, the required time (processing time) for each set can be reduced, so that the productivity can be increased (shown in FIG. 13B(5)).

A first aspect of the present invention is a sheet superposing device to superpose sheets supplied from an image forming device, and eject the superposed sheets to a finishing device following the sheet superposing device, the sheet superposing device including: a control section to obtain sheet structure information indicating a structure of sheets of a set, the set on which finishing is performed; judge whether or not a number of the sheets of the set is two or more based on the obtained sheet structure information; and superpose two sheets or more of the sheets of the set when the number of the sheets of the set is two or more.

A second aspect of the present invention is an image forming system including: an image forming device to form an image on a sheet; the sheet superposing device to superpose sheets, on each of which an image is formed by the image forming device; and a finishing device to receive the sheets superposed by the sheet superposing device, and perform finishing on the superposed sheets.

Preferably, the sheet superposing device further includes a communication section to communicate with the image forming device, wherein the control section judges whether the sheet structure information is obtained or not based on whether the sheet structure information is received via the communication section or not, and determines, based on the sheet structure information, a superposition pattern of the sheets of the set and a supply timing at which each of the sheets is supplied from the image forming device when the control section judges that the sheet structure information is obtained.

Preferably, in the sheet superposing device, the control section determines the superposition pattern and the supply timing based on sheet information on each of the sheets when the control section judges that the sheet structure information is not obtained.

Preferably, in the sheet superposing device, the sheet structure information includes at least one of: the number of the sheets of the set; a sheet number in the set; a type of finishing performed by the finishing device; a size; a paper type; a basis weight; last sheet information indicating that a sheet is a last sheet in the set or not; delay information indicating that delaying a supply timing at which a sheet is supplied from the image forming device is necessary or not; and a superposed-sheet number information indicating a number of sheets to be superposed, with regard to each of the sheets of the set.

### BRIEF DESCRIPTION OF THE DRAWINGS

The present invention will be understood fully from the detailed description given hereinbelow and the accompanying drawings, which are given by way of illustration only, and thus are not intended as a definition of the limits of the present invention, and wherein:

FIG. 1 shows a structure of an image forming system according to an embodiment of the present invention;

FIG. 2 shows an internal structure of an image forming device, a sheet superposing device, and a finishing device of the image forming system;

FIG. 3 shows communication sequence in a case where the sheet superposing device receives sheet information on each sheet from the image forming device;

FIG. 4 shows communication sequence in a case where the sheet superposing device receives sheet information on the first sheet after receiving set sheet structure information from the image forming device;

FIG. 5A shows conditions for the number of sheets to be superposed;

FIG. 5B shows conditions for sheet superposing;

FIG. 6A shows sheet-basis superposing judgment processing in a case where finishing is sorting, the number of sheets in a set is five, and sheet conditions of the five sheets are the same;

FIG. 6B shows set sheet structure information-based superposing judgment processing in the case where finishing is sorting, the number of sheets in a set is five, and sheet conditions of the five sheets are the same;

FIG. 7A shows the sheet-basis superposing judgment processing in a case where finishing is sorting, the number of sheets in a set is five, and sheet conditions of the five sheets are not the same;

FIG. 7B shows the set sheet structure information-based superposing judgment processing in the case where finishing is sorting, the number of sheets in a set is five, and sheet conditions of the five sheets are not the same;

FIG. 8A shows the sheet-basis superposing judgment processing in a case where finishing is stapling, the number of sheets in a set is six, and sheet conditions of the six sheets are the same;

FIG. 8B shows the set sheet structure information-based superposing judgment processing in the case where finishing is stapling, the number of sheets in a set is six, and sheet conditions of the six sheets are the same;

FIG. 9A shows a sheet information table in the case where finishing is sorting, the number of sheets in a set is five, and sheet conditions of the five sheets are the same;

FIG. 9B shows the sheet information table in the case where finishing is sorting, the number of sheets in a set is five, and sheet conditions of the five sheets are not the same;

FIG. 9C shows the sheet information table in the case where finishing is stapling, the number of sheets in a set is six, and sheet conditions of the six sheets are the same;

FIGS. 10A and 10B are a flow chart showing superposition pattern determination processing;

FIGS. 11A and 11B are a flow chart showing set-basis superposition pattern determination processing;

FIG. 12 is a flowchart showing sheet-basis superposition pattern determination processing;

FIG. 13A shows the sheet-basis superposing judgment processing; and

FIG. 13B shows the set sheet structure information-based superposing judgment processing.

### DESCRIPTION OF THE PREFERRED EMBODIMENT

Hereinafter, an embodiment of the present invention is described in detail referring to the accompanying drawings. However, the scope of the present invention is not limited to the drawings.

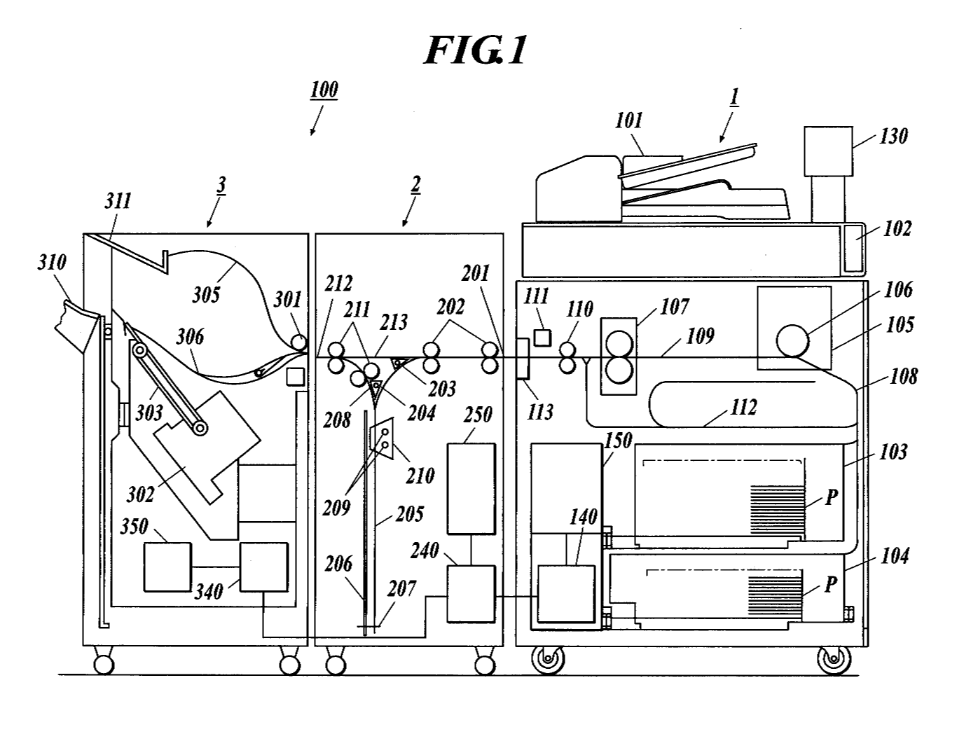

First, a structure of an image forming system 100 according to an embodiment of the present invention is described referring to FIG. 1. As shown in FIG. 1, the image forming system 100 includes an image forming device 1, a sheet superposing device 2, and a finishing device 3.

The image forming device 1 includes an automatic document feeder 101 and an image reader 102 on the upper part, and a printing section at the lower part.

The printing section includes sheet feeding sections 103 and 104 to accommodate sheets of paper P. The printing section also includes an image forming section 105 and a fixing device 107. The image forming section 105 includes a photoreceptor 106. An image is formed on a sheet by electrophotography at the image forming section 105, and the formed image is fixed at the fixing device 107.

A sheet which is supplied from the sheet feeding section 103 or 104 and on which an image is formed is ejected from a sheet ejection slit 113 by a sheet ejection roller 110.

As carry paths for a sheet, a sheet feeding path 108 from the sheet feeding sections 103 and 104 to the image forming section 105, a carry path 109 from the image forming section 105 to the sheet ejection slit 113 via the fixing device 107 and the sheet ejection roller 110, and a reverse carry path 112 for reversing and carrying a sheet are provided.

As image forming modes, a facedown sheet ejection single-sided mode, a faceup sheet ejection single-sided mode, and a both-sided mode are provided. By the facedown sheet ejection single-sided mode, an image is formed on one side of a sheet, and the sheet passes through the fixing device 107, is reversed by reverse processing, and is carried by the sheet ejection roller 110 so as to be ejected.

By the faceup sheet ejection single-sided mode, an image is formed on one side of a sheet, and the sheet follows the carry path 109, and is carried by the sheet ejection roller 110 without being reversed so as to be ejected.

By the both-sided mode, an image is formed on one side of a sheet, and the sheet passes through the fixing device 107, moves downward to follow the reverse carry path 112 so as to be reversed, and is re-fed to the sheet feeding path 108.

After that, an image (reverse-side image) is formed on the other side (reverse side) of the sheet at the image forming section 105, and the sheet on which the reverse-side image is formed passes through the fixing device 107, and is carried by the sheet ejection roller 110 so as to be ejected.

A sheet ejection sensor 111 detects presence or no-presence of a sheet. The sheet ejection sensor 111 is set up near the sheet ejection slit 113, and detects the top-end position and the tail-end position of a sheet in the carrying direction, the sheet which is to be ejected from the sheet ejection slit 113.

An operation section 130 is used for displaying and setting various kinds of modes for the image forming device 1, output modes, the output performed by the finishing device 3, conditions for sheet superposing, and the like.

A communication section 140 performs serial communications, and gives and receives information on sheet superposing including the conditions for sheet superposing to/from a front-stage communication section 241 described below of the sheet superposing device 2.

An image forming device control section 150 controls each device, section, part, and the like of the image forming device 1.

The sheet superposing device 2 superposes a plurality of sheets, the sheets being carried in from a sheet reception slit 201, and ejects the sheets to the finishing device 3.

The sheet superposing device 2 includes a superposing section 205, a carry path 213 for carrying a sheet to the sheet ejection slit 212 without sheet superposing, a carry path changing gate 203 for changing a path of a sheet toward the superposing section 205 or toward the carry path 213, and an adjustment board 210 for adjusting positions of superposed sheets.

First, a case where sheets are superposed is described.

In this case, a sheet which is ejected from the image forming device 1 enters in the sheet reception slit 201, and a roller 202 is rotated at the same speed as the linear speed for sheet ejection of the image forming device 1 so as to receive the sheet. The sheet is deposited at the superposing section 205 by switching the direction of the carry path changing gate 203 and switching the direction of a deposition changing gate 204 toward the superposing section 205.

The lower end of the sheet which moves into the superposing section 205 along a guiding shaft 206 touches an adjustment board 207 by switching the direction of the deposition changing gate 204 to the other direction and raising the adjustment board 207 which moves along the guiding shaft 206 in the vertical direction, so that the upper end of the sheet moves in a carry path 208.

Next, another sheet ejected from the image forming device 1 is received by the sheet superposing device 2 similarly, and the sheet is superposed on the previously received sheet at the superposing section 205.

Here, the adjustment board 207 is lowered at the time when the top-end in the carrying direction (lower end) of the another sheet passes through the deposition changing gate 204, so that the upper end of the superposed sheets (bundle of sheets) is located lower than the deposition changing gate 204.

The lower end of the bundle of sheets touches the adjustment board 207 by switching the direction of the deposition changing gate 204 to the other direction and raising the adjustment board 207, so that the upper end of the bundle of sheets moves in the carry path 208.

The operation described above is repeated until the operation is performed on the last sheet for sheet superposing.

When a sheet deposited and superposed at the superposing section 205 is the last sheet for sheet superposing, the position of the bundle of sheets is adjusted such that the bundle of sheets is completely aligned in the width direction thereof by the adjustment board 210 which moves along a guiding shaft 209 in the horizontal direction and adjusts the position of the bundle of sheets from both sides thereof.

When the adjustment of the position of the bundle of sheets in the horizontal direction is completed, the adjustment board 207 is raised until the upper end of the bundle of sheets reaches a roller 211.

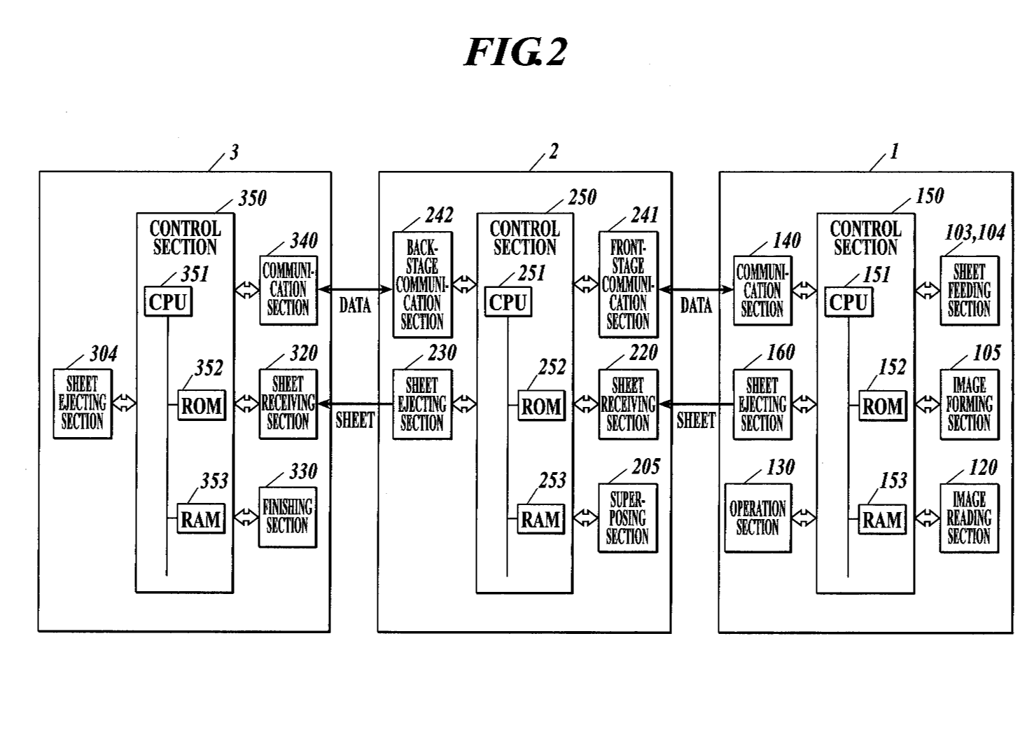

When the upper end of the bundle of sheets reaches the roller 211, the roller 211 is rotated at the same speed as the linear speed for sheet reception of the finishing device 3, so that the bundle of sheets is ejected from the sheet ejection slit 212 to the finishing device 3. A back-stage communication section 242 (shown in FIG. 2) receives information on the linear speed for sheet reception of the finishing device 3 from the finishing device 3 in advance.

Next, a case where sheets are not superposed is described.

In this case, a sheet which is ejected from the image forming device 1 enters in the sheet reception slit 201, and the roller 202 and the roller 211 are rotated at the same speed as the linear speed for sheet reception of the image forming device 1 so as to receive the sheet. The sheet enters in the carry path 213 by switching the direction of the carry path changing gate 203 toward the carry path 213.

The speed of the roller 202 and the roller 211 are changed to be the same speed as the linear speed for sheet reception of the finishing device 3 at the time when the tail end of the sheet comes out of the sheet ejection roller 110 of the image forming device 1. Then, the sheet is ejected from the sheet ejection slit 212 to the finishing device 3.

A communication section 240 performs serial communications, and includes the front-stage communication section 241 (shown in FIG. 2) and the back-stage communication section 242. The front-stage communication section 241 gives and receives the information on sheet superposing to/from the communication section 140 of the image forming device 1. The back-stage communication section 242 gives and receives the information on sheet superposing to/from a communication section 340 described below of the finishing device 3.

A sheet superposing device control section 250 controls each device, section, part, and the like of the sheet superposing device 2.

The finishing device 3 performs at least one of punching, folding, stacking, sorting, and stapling.

FIG. 1 shows a stapling section 302 and a stacker 303 of the finishing device 3. The finishing device 3 performs finishing, for example, stapling, or shifting by which sheets are shifted, on the superposed sheets which are brought from a sheet receiving roller 301, and ejects the sheets to an up-down sheet ejection tray 310.

The finishing device 3 includes a fixed sheet ejection tray 311. In a case of an image forming job for a small number of sheets, the sheets follow a carry path 305 to be ejected to the fixed sheet ejection tray 311.

Punching is performed by a punching section (not shown) after a prescribed number of sheets are stacked at the stacker 303, the sheets being carried to the stacker 303 following a carry path 306. The bundle of sheets on which punching is performed is ejected to the up-down sheet ejection tray 310 by raising the stacker 303.

Folding is performed by a folding section (not shown) after a prescribed number of sheets are stacked at the stacker 303, the sheets being carried to the stacker 303 following the carry path 306. The bundle of sheets on which folding is performed is ejected to the up-down sheet ejection tray 310 by raising the stacker 303.

Stacking is processing by which a prescribed number of sheets are stacked at the stacker 303, the sheets being carried to the stacker 303 following the carry path 306. The bundle of sheets which are stacked is ejected to the up-down sheet ejection tray 310 by raising the stacker 303.

Sorting is processing by which a position of each set of sheets is adjusted at the stacker 303, and each set of sheets is ejected to the up-down sheet ejection tray 310 such that sets of sheets are not aligned with each other thereon, after each set of sheets is carried to the stacker 303 following the carry path 306.

Stapling is performed by the stapling section 302 after a prescribed number of sheets are stacked at the stacker 303, the sheets being carried to the stacker 303 following the carry path 306. The bundle of sheets on which stapling is performed is ejected to the up-down sheet ejection tray 310 by raising the stacker 303.

For an image forming job for a small number of sheets, a carry path 305 is selected so as to eject the sheets to the fixed sheet ejection tray 311.

In a case of a mode which does not perform finishing such as stapling or shifting, sheets are ejected to the up-down sheet ejection tray 310 via the carry path 306 when image forming is performed on a large number of sheets.

Namely, in a case where image forming is performed on a large number of sheets without finishing, the sheets are ejected to the up-down sheet ejection tray 310 via the carry path 306 but not via the stacker 303.

The communication section 340 performs serial communications, and gives and receives the information on sheet superposing (information on a finishing type, in particular) to/from the image forming device 1 via the communication section 240 of the sheet superposing device 2.

A finishing device control section 350 controls each device, section, part, and the like of the finishing device 3.

Next, a functional structure of the image forming system 100 is described referring to FIG. 2.

The image forming device 1 includes the image forming device control section 150, the sheet feeding sections 103 and 104, the image forming section 105, the image reading section 120, the operation section 130, the communication section 140, and a sheet ejecting section 160. In the following, the sections which are not shown in FIG. 1 are mainly described.

The image forming device control section 150 includes a central processing unit (CPU) 151, a read only memory (ROM) 152, and a random access memory (RAM) 153.

The CPU 151 reads a program specified from among a system program and various application programs stored in the ROM 152, and expands the specified program in the RAM 153. The CPU 151 performs various processing by working in cooperation with each program expanded in the RAM 153 so as to perform centralized control of the sections and the like of the image forming device 1.

The ROM 152 is a recording medium on which information is rewritable, and stores the various programs executed by the CPU 151.

The RAM 153 is a volatile memory, and includes a work area to store each of the various programs to be executed by the CPU 151, data for each of the various programs, and the like.

The image reading section 120 includes the image reader 102, and has a function to read images based on information received by the operation section 130.

The operation section 130 includes a touch panel. The operation section 130 receives an instruction from a user, and outputs an operation signal of the instruction to the image forming device control section 150.

The communication section 140 gives and receives information to/from the front-stage communication section 241 of the sheet superposing device 2.

The sheet ejecting section 160 includes the sheet ejection roller 110, the sheet ejection sensor 111, and the sheet ejection slit 113. The sheet ejecting section 160 ejects a sheet on which image forming is performed by the image forming section 105 to a sheet receiving section 220 of the sheet superposing device 2.

The sheet superposing device 2 includes the sheet superposing device control section 250 as a control section, the front-stage communication section 241 and the back-stage communication section 242 as communication sections (communication section 240), the sheet receiving section 220, a sheet ejecting section 230, and the superposing section 205. In the following, the sections which are not shown in FIG. 1 are mainly described.

The sheet superposing device control section 250 includes a CPU 251, a ROM 252, and a RAM 253.

The CPU 251 reads a program specified from among a system program and various application programs stored in the ROM 252, and expands the specified program in the RAM 253. The CPU 251 performs various processing by working in cooperation with each program expanded in the RAM 253 so as to perform centralized control of the sections and the like of the sheet superposing device 2.

More specifically, the CPU 251 obtains set sheet structure information by receiving the set sheet structure information from the image forming device 1 via the front-stage communication section 241. Then, the CPU 251 judges whether or not the number of sheets in a set is two or more based on the set sheet structure information. When the CPU 251 judges that the number of sheets in the set is two or more, two sheets or more of the set are superposed by the CPU 251.

The CPU 251 also determines a superposition pattern and a supply timing based on the set sheet structure information. The superposition pattern indicates a pattern of superposition of sheets in a set. For example, the superposition pattern indicates a pattern in which two sheets which are the first and second sheets of the first set are superposed, and three sheets which are the third, fourth, and fifth sheets of the first set are superposed. The supply timing indicates a timing to supply (eject) a sheet from the image forming device 1 to the sheet superposing device 2 (sheet ejection timing, hereinafter).

The sheet receiving section 220 receives a sheet ejected (supplied) from the sheet ejecting section 160 of the image forming device 1.

The sheet ejecting section 230 includes the roller 211 and the sheet ejection slit 212, and ejects sheets to a sheet receiving section 320 of the finishing device 3. The superposing section 205 performs superposition of sheets (sheet superposing).

The finishing device 3 includes the finishing device control section 350, the communication section 340, the sheet receiving section 320, a finishing section 330, and a sheet ejecting section 304. In the following, the sections which are not shown in FIG. 1 are mainly described.

The finishing device control section 350 includes a CPU 351, a ROM 352, and a RAM 353.

The CPU 351 reads a program specified from among a system program and various application programs stored in the ROM 352, and expands the specified program in the RAM 353. The CPU 351 performs various processing by working in cooperation with each program expanded in the RAM 353 so as to perform centralized control of the sections and the like of the finishing device 3.

The sheet receiving section 320 receives sheets ejected from the sheet ejecting section 230 of the sheet superposing device 2.

The finishing device 330 includes the stapling section 302 and the stacker 303, and performs finishing such as stapling.

The sheet ejecting section 304 includes the up-down sheet ejection tray 310 and the fixed sheet ejection tray 311, and performs sheet ejection control to the up-down sheet election tray 310 and up-down control of the up-down sheet ejection tray 310.

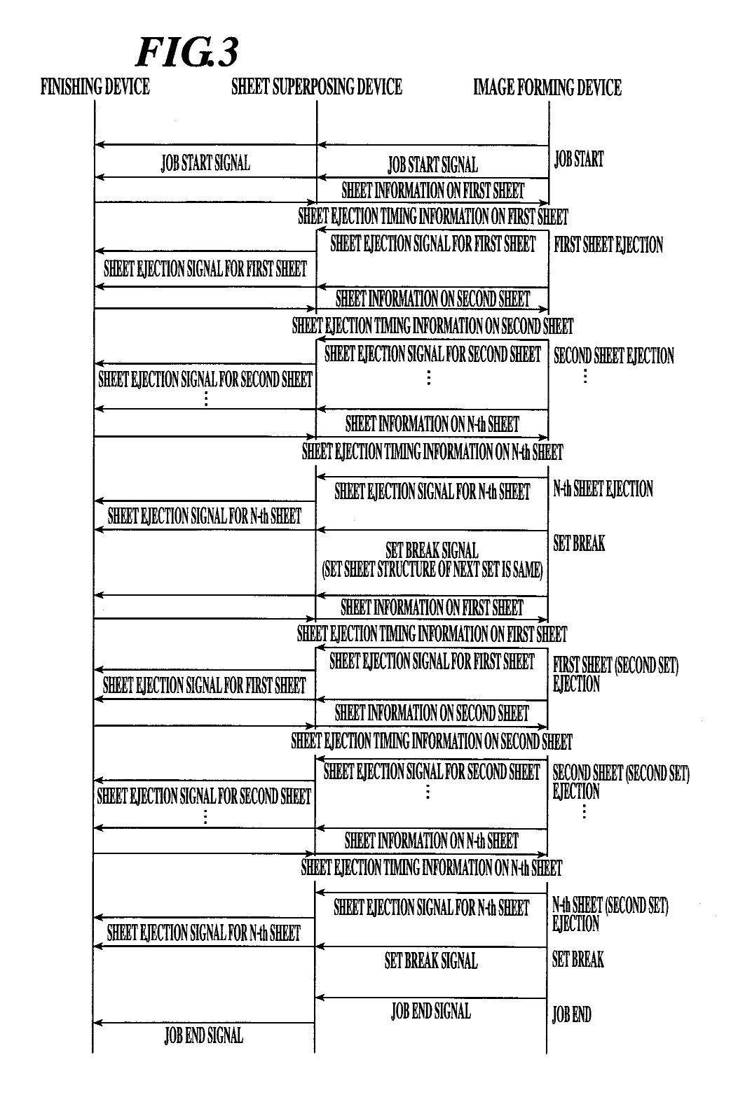

Next, operation of the image forming system 100 is described. First, communication sequence in a case where the sheet superposing device 2 receives sheet information on each sheet from the image forming device 1 is described referring to FIG. 3. The sheet information includes information on a finishing type (stapling, sorting, punching, or folding, for example), the size of a sheet (length and width), the paper type of a sheet (plain paper, enamel paper, book paper, or rough paper, presence or no-presence of Tab (index tab), presence or no-presence of punch holes, a manufacturer, a brand, and the like), the basis weight (g/m²) of a sheet, and sheet-ejection tray information (that a sheet is ejected to a main-tray (the up-down sheet ejection tray 310) or a sub-tray (the fixed sheet ejection tray 311)).

When a job starts at the image forming device 1, a job start signal is sent to the sheet superposing device 2. Then, the job start signal is received by the sheet superposing device 2, and the received job start signal is sent to the finishing device 3.

Sheet information on the first sheet is sent from the image forming device 1 to the sheet superposing device 2 at a timing right before the sheet is ejected from the image forming device 1.

Then, the sheet information on the first sheet is received by the sheet superposing device 2, and the received sheet information on the first sheet is sent to the finishing device 3. The sheet information on the first sheet is received by the finishing device 3, and sheet ejection timing information on the first sheet is sent to the sheet superposing device 2 thereafter. The sheet ejection timing information is information for instructing a timing to eject a sheet from the image forming device 1 to the sheet superposing device 2. The sheet ejection timing information is generated by at least one of the finishing device 3 and the sheet superposing device 2.

The sheet ejection timing information on the first sheet is received by the sheet superposing device 2, and the received sheet ejection timing information on the first sheet is sent to the image forming device 1.

The image forming device 1 receives the sheet ejection timing information on the first sheet, and ejects the first sheet based on the sheet ejection timing information on the first sheet. At the same time as the timing when the first sheet is ejected, a sheet ejection signal for the first sheet is sent to the sheet superposing device 2. The sheet ejection signal is a signal for controlling operation (rotation of the roller 202, for example) of the sheet superposing device 2. The timing for the image forming device 1 to eject a sheet (sheet ejection interval between ejection of a sheet and ejection of the previous sheet) is controlled in the image forming device 1 based on sheet ejection timing information on each sheet.

The same processing described above is repeated until the processing is performed on the last sheet (n-th sheet) of a set.

Then, a set break signal is sent from the image forming device 1 to the sheet superposing device 2. The set break signal is a signal for indicating a break between sets (a break between the first set and the second set, for example). Information is set into the set break signal, the information which indicates that the next set (second set) and the previous set (first set) have the same set sheet structure or that the next set (second set) and the previous set (first set) do not have the same set sheet structure.

The set break signal is received by the sheet superposing device 2. When the set break signal is received by the sheet superposing device 2, set sheet structure information is finalized, and the finalized set sheet structure information is stored in the RAM 253. Then, the set break signal is sent to the finishing device 3 from the sheet superposing device 2. The same processing described above is repeated for the second set and thereafter.

Then, a job end signal is sent from the image forming device 1 to the sheet superposing device 2. The job end signal is received by the sheet superposing device 2, and the received job end signal is sent to the finishing device 3. Then, the job end signal is received by the finishing device 3.

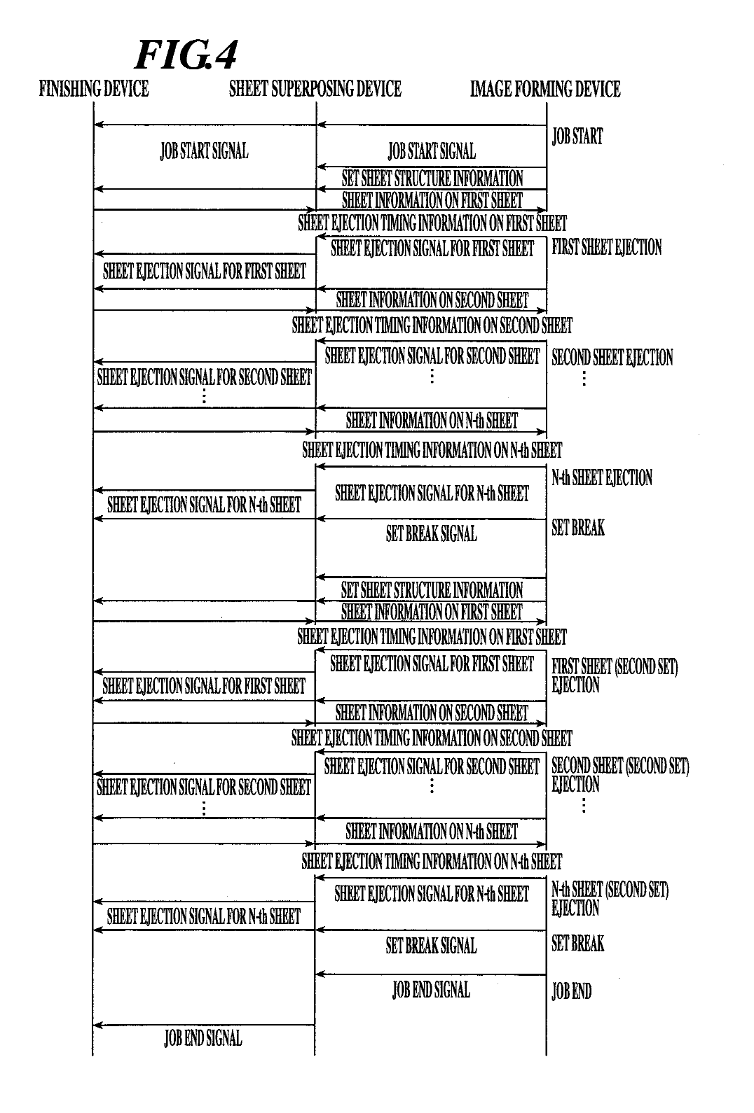

Next, communication sequence in a case where the sheet superposing device 2 receives sheet information on the first sheet after receiving set sheet structure information is described referring to FIG. 4. In the following, the difference from the communication sequence shown in FIG. 3 is mainly described.

As shown in FIG. 4, set sheet structure information (set sheet structure information on the first set) is sent from the image forming device 1 to the sheet superposing device 2. Then, sheet information on the first sheet is sent from the image forming device 1 to the sheet superposing device 2. Similarly, for the second set and thereafter, after set sheet structure information on their respective sets is sent, sheet information on the first sheet of their respective sets is sent, from the image forming device 1 to the sheet superposing device 2.

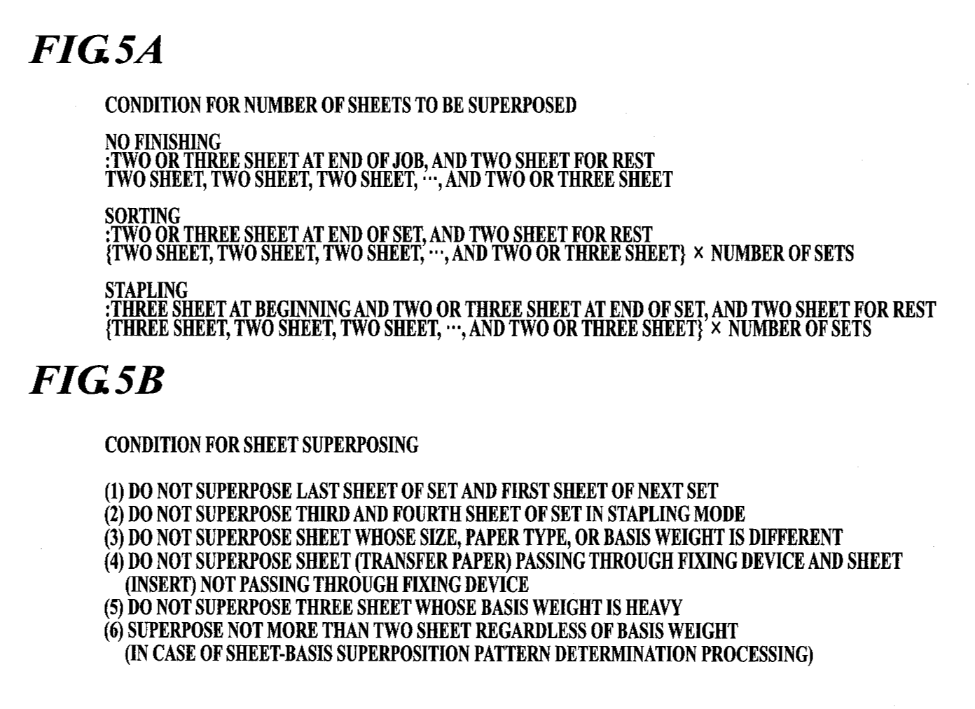

Sheet superposing performed at the sheet superposing device 2 is described referring to FIGS. 5A and 5B. First, conditions for the number of sheets to be superposed are described. A condition for the number of sheets to be superposed is a condition for determining a prescribed number of sheets to be superposed. The condition for the number of sheets to be superposed is determined in accordance with a finishing type.

For example, when no finishing is performed, the condition for the number of sheets to be superposed is “two or three sheets at the end of a job, and two sheets for the rest”. Namely, the last two or three sheets of a job are superposed, and two sheets are superposed with regard to the rest of the sheets of the job (the other sheets except the last two or three sheets of the job). More specifically, as shown in FIG. 5A, the condition for the number of sheets to be superposed is “two sheets, two sheets, two sheets, . . . , and two or three sheets”.

When finishing is sorting, the condition for the number of sheets to be superposed is “two or three sheets at the end of each set, and two sheets for the rest”. Namely, the last two or three sheets of each set are superposed, and two sheets are superposed with regard to the rest of the sheets of each set (the other sheets except the last two or three sheets of each set). This is to avoid carrying only one sheet (ejecting only one sheet to the finishing device 3) at the end of each set, and accordingly avoid delaying a sheet ejection timing for the first sheet of the next set. More specifically, as shown in FIG. 5A, the condition for the number of sheets to be superposed is “{two sheets, two sheets, two sheets, . . . , and two or three sheets}×the number of sets”.

When finishing is stapling, the condition for the number of sheets to be superposed is “three sheets at the beginning of each set, two or three sheets at the end of each set, and two sheets for the rest”. Namely, the first three sheets of each set are superposed, the last two or three sheets of each set are superposed, and two sheets are superposed with regard to the rest of the sheets of each set (the other sheets except the first three sheets and the last two or three sheets of each set). The reason why the first three sheets of each set are superposed in this case is to secure time for performing stapling on the sheets of the previous set. The reason why the last two or three sheets of each set are superposed in this case is to avoid carrying only one sheet at the end of each set, and accordingly avoid delaying a sheet ejection timing for the first sheet of the next set, which is the same reason as the reason in the case where finishing is sorting. More specifically, as shown in FIG. 5A, the condition for the number of sheets to be superposed is “{three sheets, two sheets, two sheets, . . . , and two or three sheets}×the number of sets”.

Basically, sheet superposing is performed based on the above-mentioned conditions at the sheet superposing device 2. However, there is a case where sheet conditions of sheets in a set are different (paper types and/or the like of sheets in a set are different). In this case, sheet superposing is performed based on exceptional conditions (conditions for sheet superposing). More specifically, as shown in FIG. 5B, sheet superposing is performed based on one or more of the following conditions for sheet superposing: (1) the last sheet of a set and the first sheet of the next set are not superposed; (2) when finishing is stapling, the third and fourth sheets of a set are not superposed; (3) sheets which are different in size, paper type, and/or basis weigh are not superposed; (4) a sheet (transfer paper) which passes through the fixing device 107 and a sheet (insert) which does not pass through the fixing device 107 are not superposed; (5) In a case of thick paper (a sheet whose basis weigh is heavy), three sheets are not superposed (not more than two sheets are superposed in a case where the basis weight of a sheet is 130 g/m² or more); and (6) not more than two sheets are superposed regardless of the basis weight (in a case of sheet-basis superposition pattern determination processing).

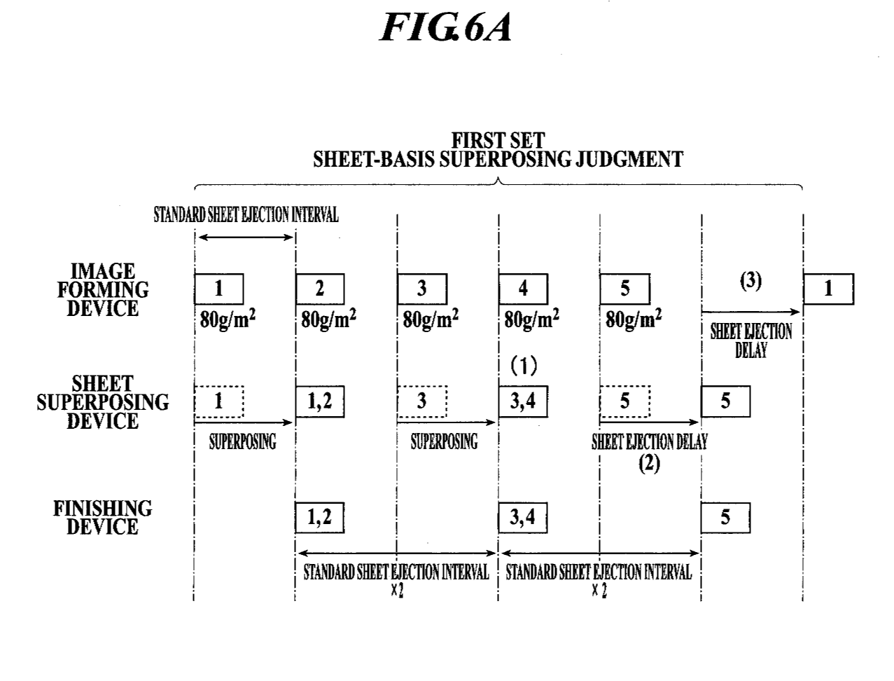

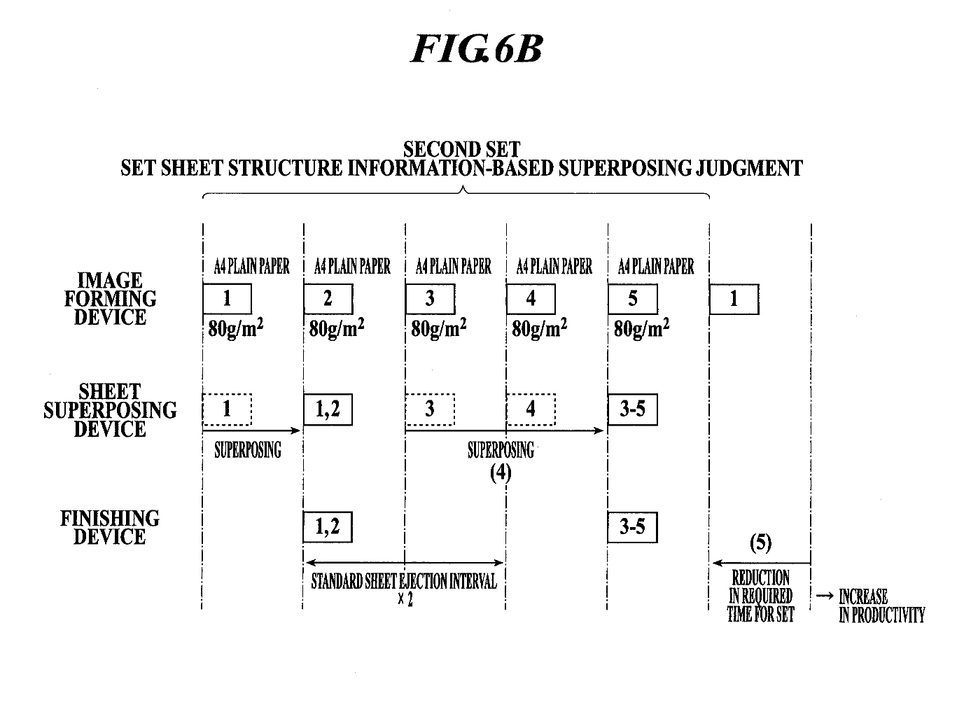

Next, a superposition pattern and a sheet ejection timing are described referring to FIGS. 6A to 8B. In the cases shown in FIGS. 6A to 8B, the sheet-basis superposing judgment processing (processing to determine a superposition pattern and a sheet ejection timing based on sheet information on each sheet) is performed on the first set of sheets, and the set sheet structure information-based superposing judgment processing (processing to determine a superposition pattern and a sheet ejection timing based on set sheet structure information) is performed on the second set of sheets. In addition, sheet superposing is performed based on the conditions for the number of sheets to be superposed and the conditions for sheet superposing. Moreover, it is necessary for the finishing device 3 to secure time which is twice as long as the standard sheet ejection interval (two standard sheet ejection intervals) as the sheet reception interval which is an interval between reception of a sheet/sheets and reception of another sheet/other sheets from the sheet superposing device 2.

First, a superposition pattern and a sheet ejection timing in the case where finishing is sorting, the number of sheets in a set is five, and sheet conditions of the five sheets are the same are described referring to FIGS. 6A and 6B.

In this case, since finishing is sorting, two or three sheets are superposed at the end of a set according to the conditions for the number of sheets to be superposed. The processing performed on the first set is the sheet-basis superposing judgment processing, so that the sheet superposing device 2 cannot recognize sheet information on the fifth sheet at the time when sheet information on the fourth sheet is sent from the image forming device 1 (shown in FIG. 6A(1)). Hence, the sheet superposing device 2 has no choice but to superpose two sheets which are the third sheet and the fourth sheet. As a result, the sheet superposing device 2 needs to delay ejecting the fifth sheet (cause sheet ejection delay) to the finishing device 3 for a one-sheet period (one standard sheet ejection interval) since the finishing device 3 needs to secure two standard sheet ejection intervals as the sheet reception interval (shown in FIG. 6A(2)). In this case, the sheet superposing device 2 performs control by which ejection of the fifth sheet to the finishing device 3 is delayed for a one-sheet period. In addition, in order to delay ejecting the fifth sheet from the sheet superposing device 2 to the finishing device 3 for a one-sheet period, it is necessary to delay ejecting the first sheet of the next set (cause sheet ejection delay) from the image forming device 1 to the sheet superposing device 2 for a one-sheet period (shown in FIG. 6A(3)). Therefore, sheet ejection timing information for delaying a sheet ejection timing for a one-sheet period is sent from the sheet superposing device 2 to the image forming device 1.

The processing performed on the second set is the set sheet structure information-based superposing judgment processing, by which a superposition pattern and a sheet ejection timing is determined based on set sheet structure information. Since the set sheet structure information on the first set is stored in RAM 253 (finalized), namely, the set sheet structure information on the first set and the set sheet structure information on the second set are the same, the sheet superposing device 2 can recognize the set sheet structure information on the second set. For example, the sheet superposing device 2 can recognize sheet information on the fifth sheet at the time when sheet information on the fourth sheet is sent from the image forming device 1. As a result, the sheet superposing device 2 can superpose the third, fourth, and fifth sheets (shown in FIG. 6B(4)). Therefore, unlike in the first set, sheet ejection delay is caused neither at the sheet superposing device 2 nor at the image forming device 1. Accordingly, the required time (processing time) for each set can be reduced, and the productivity can be increased (FIG. 6B(5)). Namely, the sheet superposing device 2 can determine a superposition pattern and a sheet ejection timing which can reduce the processing time as compared with the first set.

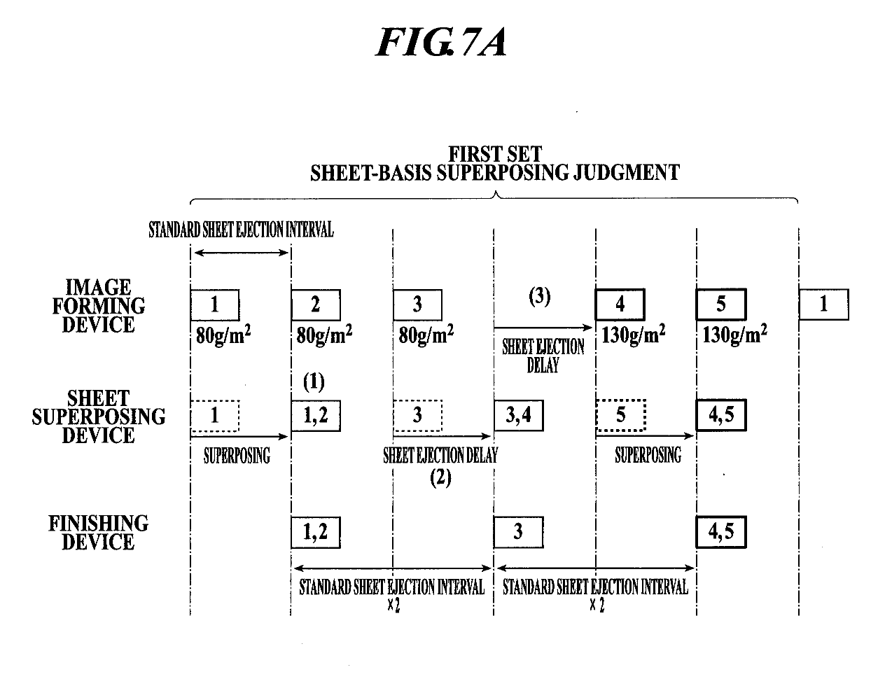

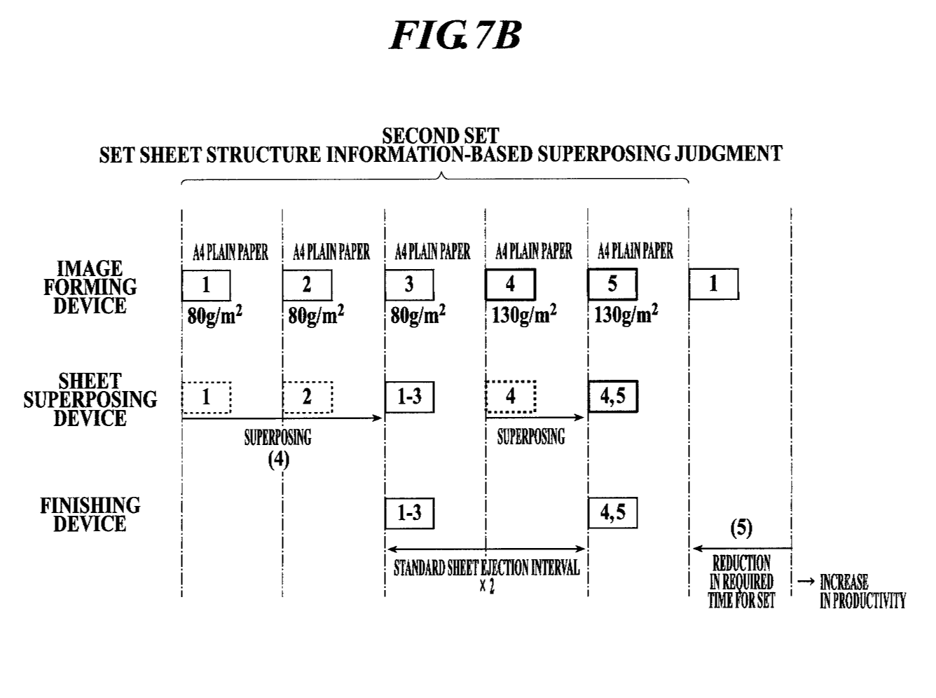

Next, a superposition pattern and a sheet ejection timing in the case where finishing is sorting, the number of sheets in a set is five, and sheet conditions of the five sheets are not the same is described referring to FIGS. 7A and 7B. As shown in FIGS. 7A and 7B, the basis weights of the first, second, and third sheets are 80 g/m², and the basis weight of the fourth sheet is 130 g/m², the sheets which are supplied from the image forming device 1 to the sheet superposing device 2. In addition, since finishing is sorting, basically, two or three sheets are superposed at the end of a set, and two sheets are superposed with regard to the rest of the sheets of the set according to the conditions for the number of sheets to be superposed. The processing performed on the first set is the sheet-basis superposing judgment processing, so that the sheet superposing device 2 cannot recognize sheet information on the third sheet and thereafter at the time when sheet information on the second sheet is sent from the image forming device 1 (shown in FIG. 7A(1)). Hence, the sheet superposing device 2 has no choice but to superpose two sheets which are the first and second sheets. As a result, the sheet superposing device 2 needs to delay ejecting the third sheet (cause sheet ejection delay) to the finishing device 3 for a one-sheet period (one standard sheet ejection interval) since the finishing device 3 needs to secure two standard sheet ejection intervals as the sheet reception interval (shown in FIG. 7A(2)). In this case, the sheet superposing device 2 performs control by which ejection of the third sheet to the finishing device 3 is delayed for a one-sheet period. In addition, in order to delay ejecting the third sheet from the sheet superposing device 2 to the finishing device 3 for a one-sheet period, it is necessary to delay ejecting the fourth sheet (cause sheet ejection delay) from the image forming device 1 to the sheet superposing device 2 for a one-sheet period (shown in FIG. 7A(3)). Therefore, sheet ejection timing information for delaying a sheet ejection timing for a one-sheet period is sent from the sheet superposing device 2 to the image forming device 1.

The processing performed on the second set is the set sheet structure information-based superposing judgment processing, by which a superposition pattern and a sheet ejection timing are determined based on set sheet structure information. Since the set sheet structure information (on the first set) is stored in RAM 253 (finalized), namely, the set sheet structure information on the first set and the set sheet structure information on the second set are the same, the sheet superposing device 2 can recognize sheet information on the third sheet and thereafter at the time when sheet information on the second sheet is sent from the image forming device 1. As a result, the sheet superposing device 2 can superpose the first, second, and third sheets (shown in FIG. 7B(4)) according to the conditions for sheet superposing. Therefore, unlike in the first set, sheet ejection delay does is caused neither at the sheet superposing device 2 nor the image forming device 1. Accordingly, the required time (processing time) for each set can be reduced, and the productivity can be increased (FIG. 7B(5)). Namely, the sheet superposing device 2 can determine a superposition pattern and a sheet ejection timing which can reduce the processing time as compared with the first set.

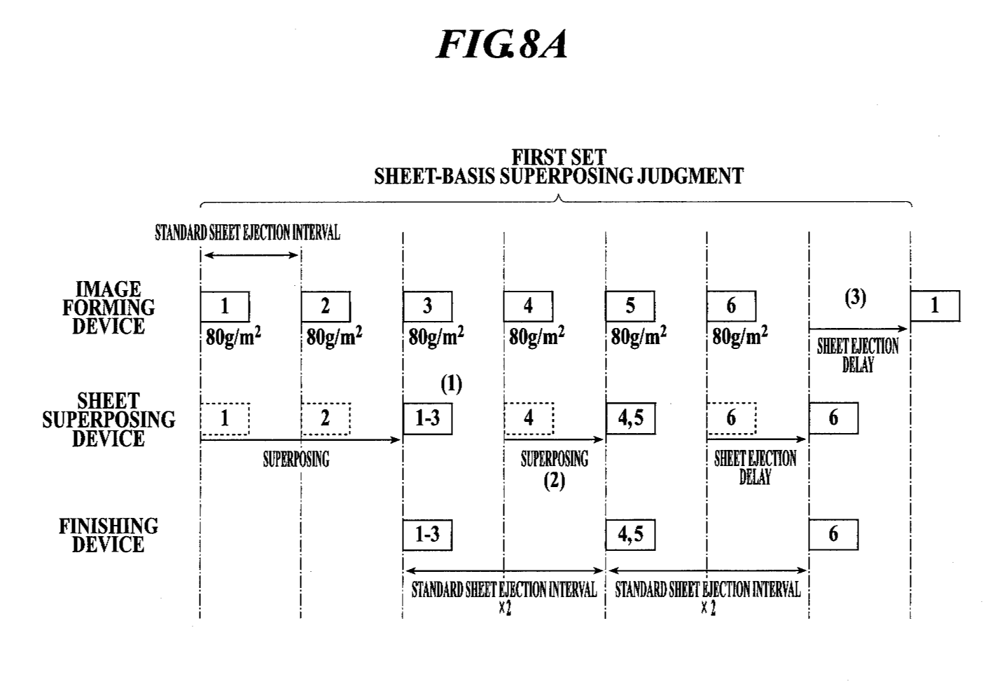

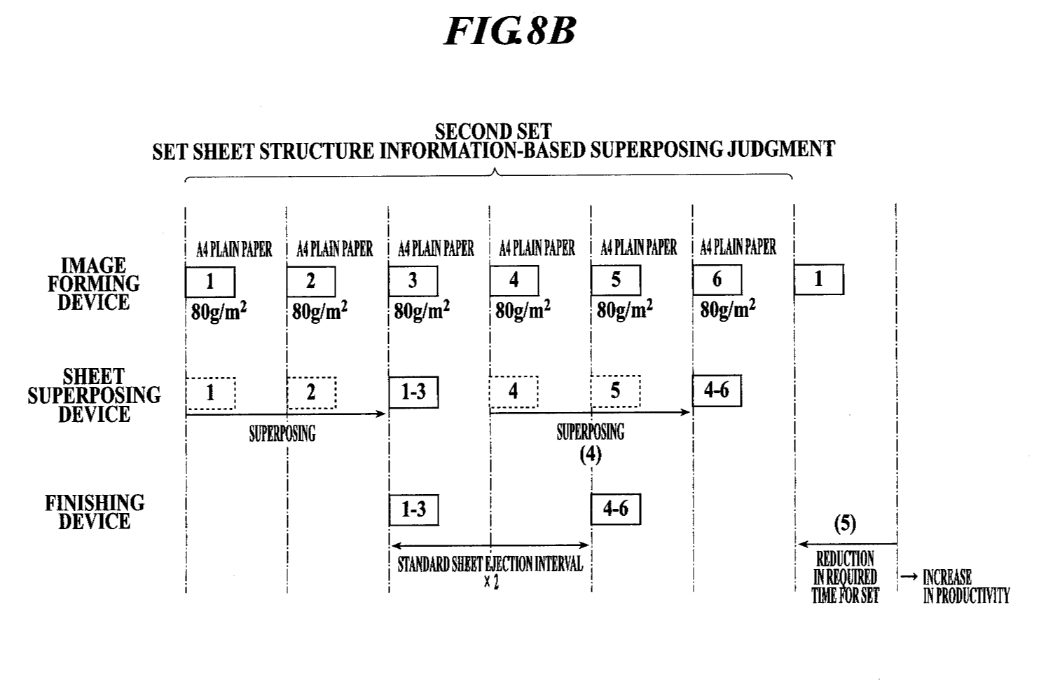

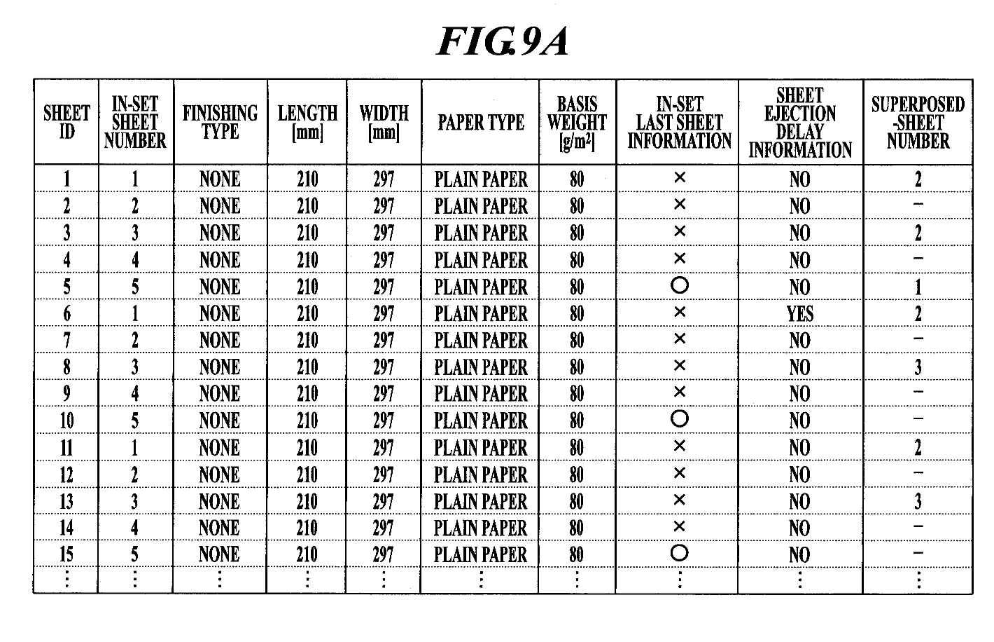

Next, a superposition pattern and a sheet ejection timing in the case where finishing is stapling, the number of sheets in a set is six, and sheet conditions of the six sheets are the same is described referring to FIGS. 8A and 8B. In addition, since finishing is stapling, three sheets (first, second, and third sheets) are superposed at the beginning of a set in accordance with the conditions for the number of sheets to be superposed. The processing performed on the first set is the sheet-basis superposing judgment processing, so that the sheet superposing device 2 cannot recognize sheet information on the sixth sheet at the time when sheet information on the fifth sheet is sent from the image forming device 1 (shown in FIG. 8A(1)). Hence, the sheet superposing device 2 has no choice but to superpose two sheets which are the fourth and the fifth sheets. As a result, the sheet superposing device 2 needs to delay ejecting the sixth sheet (cause sheet ejection delay) to the finishing device 3 for a one-sheet period (one standard sheet ejection interval) since the finishing device 3 needs to secure two standard sheet ejection intervals as the sheet reception interval (shown in FIG. 8A(2)). In this case, in order to delay ejecting the sixth sheet from the sheet superposing device 2 to the finishing device 3 for a one-sheet period, it is necessary to delay ejecting the first sheet of the next set (cause sheet ejection delay) from the image forming device 1 to the sheet superposing device 2 for a one-sheet period (shown in FIG. 8A(3)). Therefore, sheet ejection timing information for delaying a sheet ejection timing for a one-sheet period is sent from the sheet superposing device 2 to the image forming device 1.

The processing performed on the second set is the set sheet structure information-based superposing judgment processing, by which a superposition pattern and a sheet ejection timing are determined based on set sheet structure information. Since the set sheet structure information (on the first set) is stored in RAM 253 (finalized), namely, the set sheet structure information on the first set and the set sheet structure information on the second set are the same, the sheet superposing device 2 can recognize sheet information on the sixth sheet at the time when sheet information on the fifth sheet is sent from the image forming device 1. As a result, the sheet superposing device 2 can superpose the fourth, fifth, and sixth sheets (shown in FIG. 8B (4)). Therefore, unlike in the first set, sheet ejection delay is caused neither at the sheet superposing device 2 nor the image forming device 1. Accordingly, the required time (processing time) for each set can be reduced, and the productivity can be increased (FIG. 8B (5)). Namely, the sheet superposing device 2 can determine a superposition pattern and a sheet ejection timing which can reduce the processing time as compared with the first set.

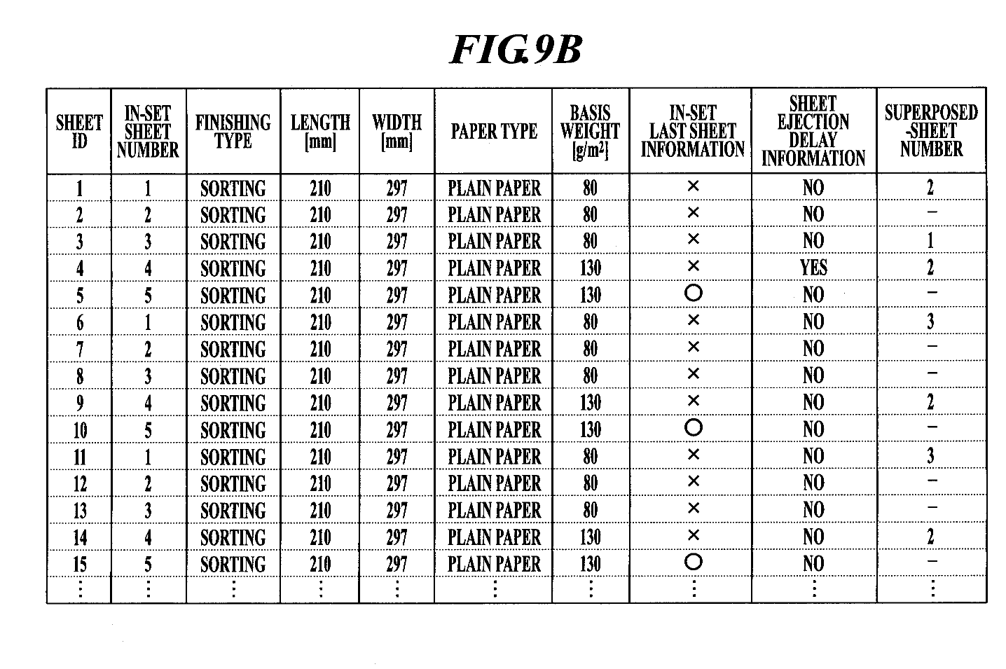

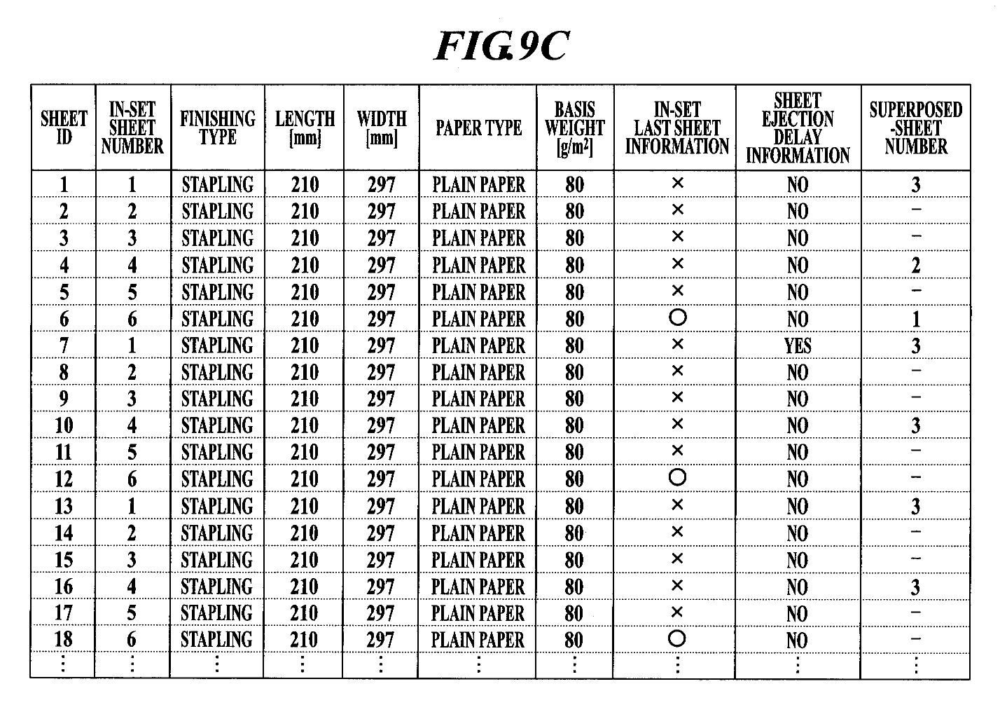

Next, a sheet information table is described referring to FIGS. 9A, 9B, and 9C. As shown in FIGS. 9A, 9B, and 9C, the sheet information table includes a sheet identification (ID), an in-set sheet number, a finishing type, and the length, the width, the paper type, and the basis weight of a sheet, and in-set last sheet information, sheet ejection delay information, and a superposed-sheet number. Sheet information on a sheet is equivalent to the above-mentioned items of a sheet in the sheet information table.

The in-set sheet number is information which indicates a sheet number in a set. The in-set last sheet information is information which indicates that a sheet is the last sheet of a set or that a sheet is not the last sheet of a set. The sheet ejection delay information is information which indicates that it is necessary to delay a sheet ejection timing, or that it is unnecessary to delay a sheet ejection timing, the sheet ejection timing which is a timing for ejecting a sheet from the image forming device 1 to the sheet superposing device 2. The superposed-sheet number is information which indicates the number of sheets to be superposed (or indicates that sheets are not superposed by the superposed-sheet number “1”).

The above-mentioned items of sheets which consist of a set in the sheet information table, namely, sheet information on sheets which consist of a set, are equivalent to set sheet structure information. For example, in the sheet information table shown in FIGS. 9A and 9B, set sheet structure information on the first set is the finishing types, the sizes (length and width), the paper types, the basis weights, the in-set last sheet information, the sheet ejection delay information, and the superposed-sheet numbers of sheets whose in-set sheet numbers are 1 to 5.

FIG. 9A shows the sheet information table in the case shown in FIGS. 6A and 6B (the case where finishing is sorting, the number of sheets in a set is five, and sheet conditions of the five sheets are the same). FIG. 9B shows the sheet information table in the case shown in FIGS. 7A and 7B (the case where finishing is sorting, the number of sheets in a set is five, and sheet conditions of the five sheets are not the same). FIG. 9C shows the sheet information table in the case shown in FIGS. 8A and 8B (the case where finishing is stapling, the number of sheets in a set is six, and sheet conditions of the six sheets are the same).

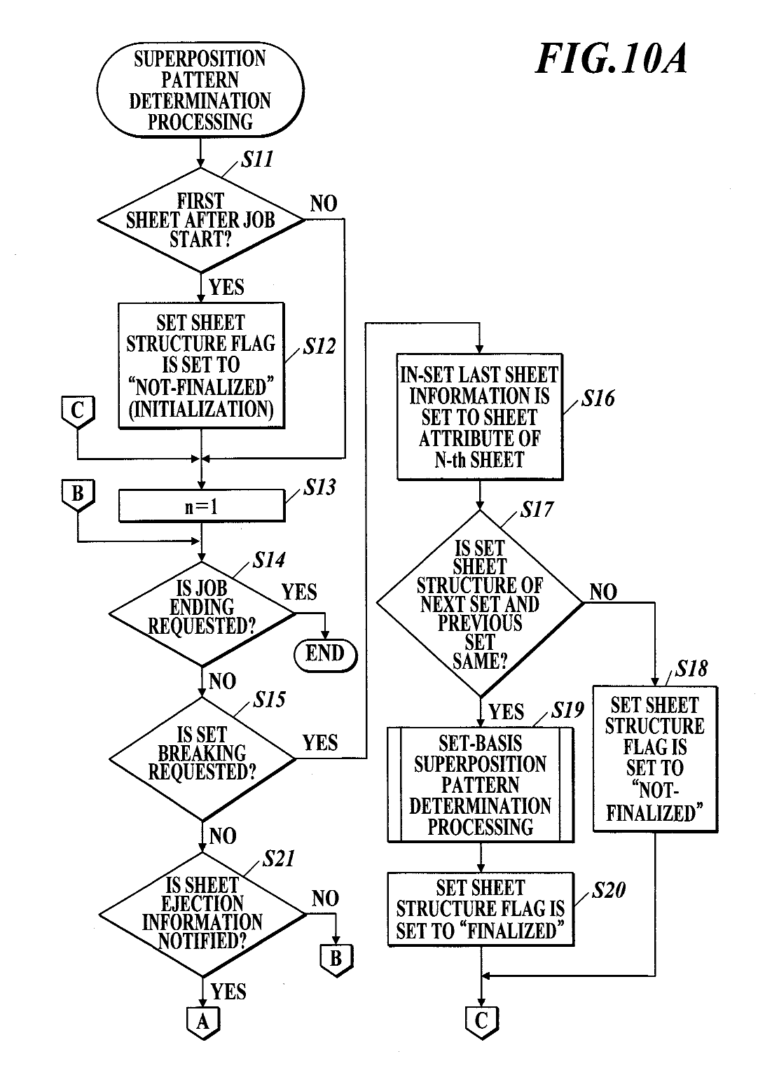

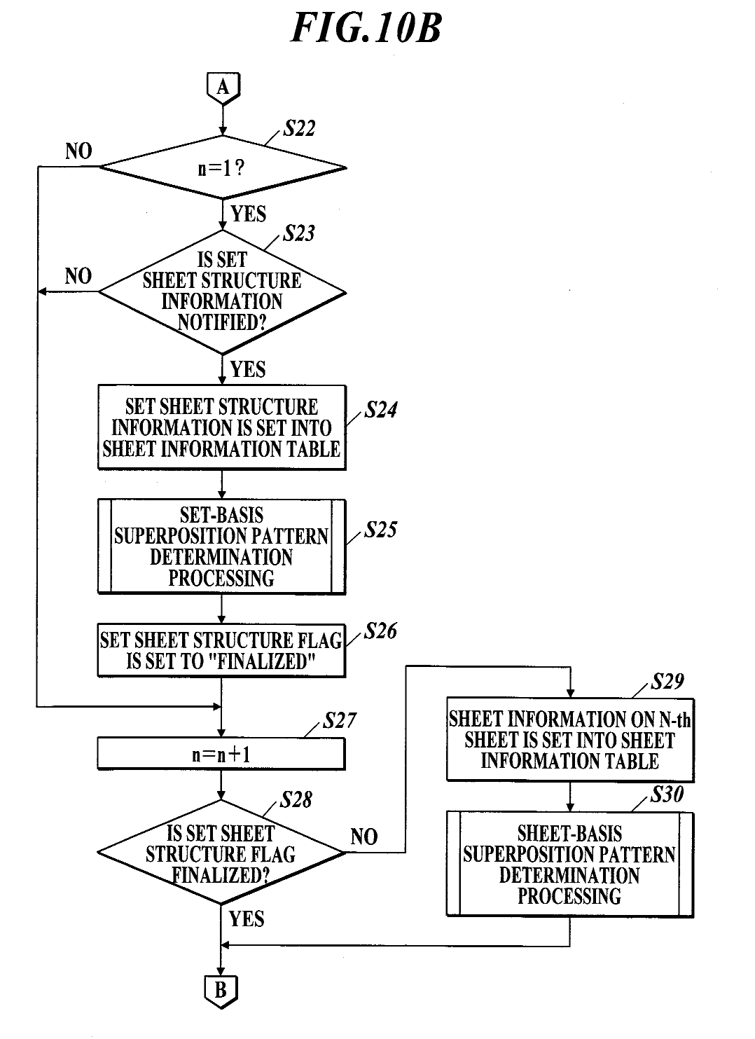

Next, superposition pattern determination processing performed at the sheet superposing device 2 is described referring to FIGS. 10A and 10B. The superposition pattern determination processing is processing for determining a pattern of superposition of sheets (superposition pattern).

The superposition pattern determination processing is performed at the sheet superposing device 2 by the CPU 251 and a sheet superposition pattern determination program read from the ROM 252 and appropriately expanded in the RAM 253 working together, which is triggered by receiving a job start signal from the image forming device 1, for example.

First, it is judged whether a sheet is the first sheet after a job starts or not (Step S11). More specifically, Step S11 is judged based on whether sheet information on the first sheet is received from the image forming device 1 right after a job start signal is received or not.

When it is judged that the sheet is not the first sheet after a job starts at Step S11 (Step S11; NO), the processing moves to Step S13 described below. When it is judged that the sheet is the first sheet after a job starts at Step S11 (Step S11; YES), a set sheet structure flag is set to “not-finalized” (initialization) (Step S12). The set sheet structure flag is a flag which indicates that set sheet structure information is finalized, or that set sheet structure information is not finalized.

After Step S12, “n” is set to “1” (Step S13). The “n” indicates a sheet number in a set.

After Step S13, it is judged whether job ending is requested or not (Step S14). More specifically, Step S14 is judged based on whether a job end signal is received from the image forming device 1 or not. When it is judged that job ending is requested at Step S14 (Step S14; YES), the superposition pattern determination processing ends.

When it is judged that job ending is not requested at Step S14 (Step S14; NO), it is judged whether set breaking is requested or not (Step S15). More specifically, Step S15 is judged based on whether a set break signal is received from the image forming device 1 or not.

When it is judged that set breaking is requested at Step S15 (Step S15; YES), in-set last sheet information is set to the sheet attribute of the n-th sheet (Step S16). More specifically, “◯” is set to the in-set last sheet information on the n-th sheet in a sheet information table.

After Step S16, it is judged whether a set sheet structure of the next set is the same as the set sheet structure of the previous set or not (Step S17). More specifically, Step S17 is judged based on the set break signal.

When it is judged that the set sheet structure of the next set is not the same as the set sheet structure of the previous set at Step S17 (Step S17; NO), the set sheet structure flag is set to “not-finalized” (Step S18). After Step S18, the processing moves to Step S13.

When it is judged that the set sheet structure of the next set is the same as the set sheet structure of the previous set at Step S17 (Step S17; YES), set-basis superposition pattern determination processing is performed (Step S19). The set-basis superposition pattern determination processing is described below. After Step S19, the set sheet structure flag is set to “finalized” (Step S20). After Step S20, the processing moves to Step S13.

When it is judged that set breaking is not requested at Step S15 (Step S15: NO), it is judged whether sheet ejection information is notified or not (Step S21). More specifically, Step S21 is judged based on whether the sheet information on the first sheet is received from the image forming device 1 or not.

When it is judged that the sheet ejection information is not notified at Step S21 (Step S21; NO), the processing moves to Step S14. When it is judged that the sheet ejection information is notified at Step S21 (Step S21; YES), it is judged whether “n” is “1” or not (Step S22).

When it is judged that “n” is not “1” at Step S22 (Step S22; NO), the processing moves to Step S27 described below. When it is judged that “n” is “1” at Step S22 (Step S22; YES), it is judged whether set sheet structure information is notified or not (Step S23). More specifically, Step S23 is judged based on whether set sheet structure information is received with the sheet information on the first sheet or not as shown in FIG. 4.

When it is judged that the set sheet structure information is not notified at Step S23 (Step S23; NO), the processing moves to Step S27 described below. When it is judged that the set sheet structure information is notified at Step S23 (Step S23; YES), the set sheet structure information is set into the sheet information table (Step S24). Namely, sheet information on each of the sheets which consist of the set is set into the sheet information table.

After Step S24, the set-basis superposition pattern determination processing is performed (Step S25). The set-basis superposition pattern determination processing is described below. The set sheet structure flag is set to “finalized” (Step S26).

After Step S26, “n” is set to “n+1” (Step S27). Then, it is judged whether the set sheet structure flag is finalized or not (Step S28).

When it is judged that the set sheet structure flag is not finalized at Step S28 (Step S28; NO), sheet information on the n-th sheet is set into the sheet information table (Step S29). After Step S29, sheet-basis superposition pattern determination processing is performed (Step S30). The sheet-basis superposition pattern determination processing is described below. After Step S30, the processing moves to Step S14. When it is judged that the set sheet structure flag is finalized at Step S28 (Step S28; YES), the processing moves to Step S14.

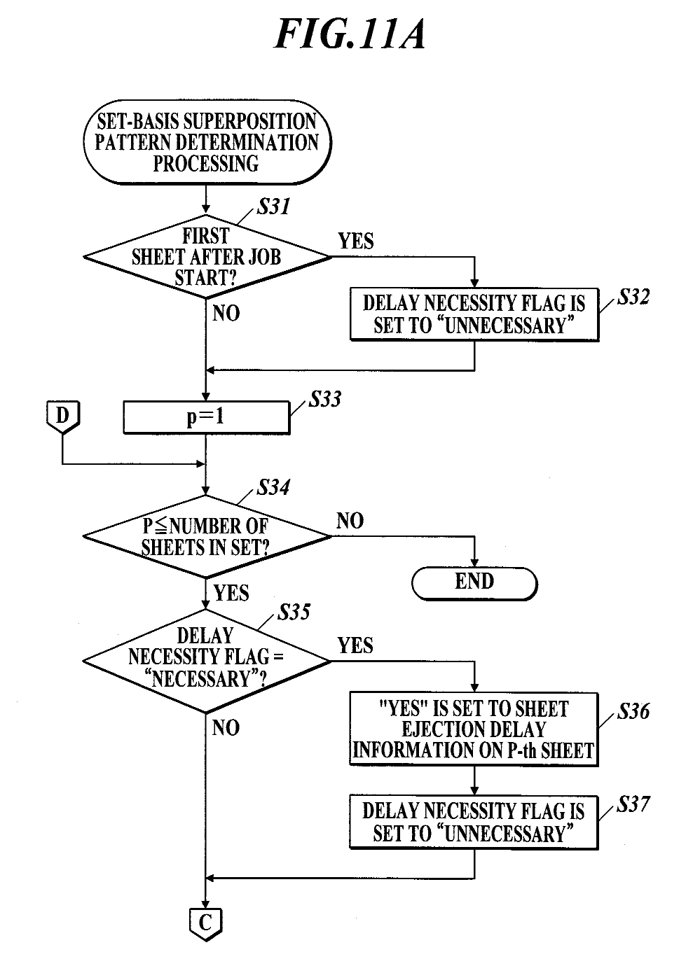

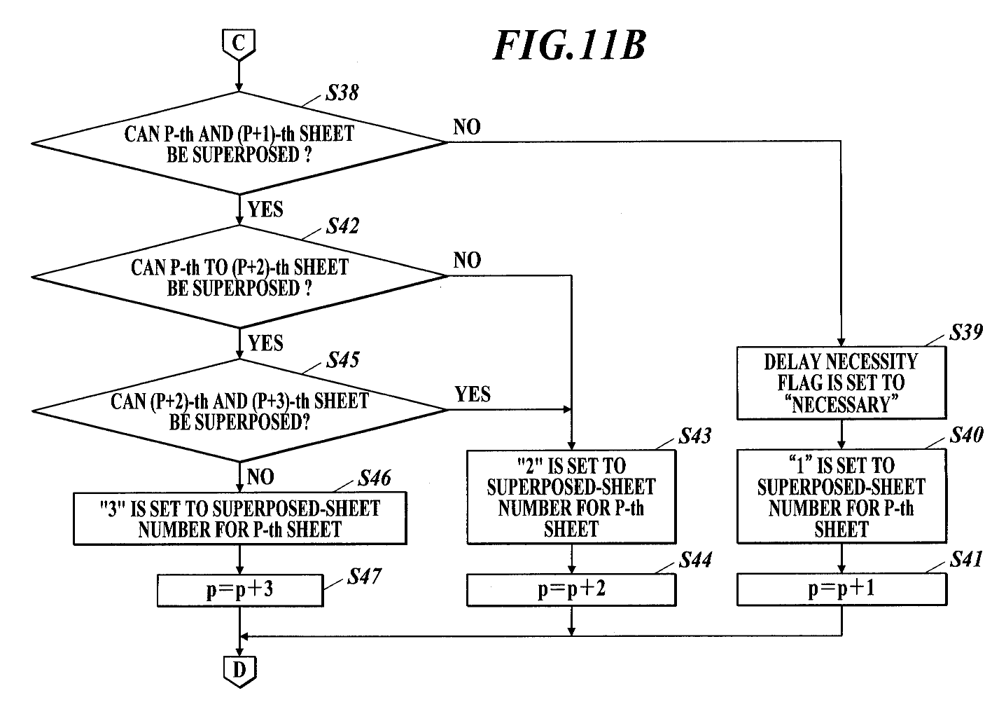

Next, the set-basis superposition pattern determination processing performed at Step S19 and Step S25 in the superposition pattern determination processing is described referring to FIGS. 11A and 11B. The set-basis superposition pattern determination processing is processing by which a superposition pattern is determined based on set sheet structure information.

First, it is judged whether a sheet is the first sheet after a job starts or not (Step S31). When it is judged that the sheet is the first sheet after a job starts at Step S31 (Step S31; YES), a delay necessity flag is set to “unnecessary” (Step S32). The delay necessity flag is a flag for judging whether delaying a sheet ejection timing is necessary or not. After Step S32, the processing moves to Step S33 described below.

When it is judged that the sheet is not the first sheet after a job starts at Step S31 (Step S31; NO), “p” is set to “1” (Step S33). The “p” indicates a sheet number in a set. Then, it is judged whether or not “p” is equal to the number of sheets in a set or less (Step S34).

When it is judged that “p” is not equal to the number of sheets in the set or less at Step S34 (Step S34; NO), the set-basis superposition pattern determination processing ends. When it is judged that “p” is equal to the number of sheets in the set or less at Step S34 (Step S34; YES), the delay necessity flag is referred to, and it is judged whether the delay necessity flag is “necessary” or not (Step S35).

When it is judged that the delay necessity flag is “necessary” at Step S35 (Step S35; YES), “YES” is set to sheet ejection delay information on the p-th sheet (Step S36). Namely, “YES” is set to the sheet ejection delay information on the p-th sheet in the sheet information table. After Step S36, the delay necessity flag is set to “unnecessary” (Step S37). After Step S37, the processing moves to Step S38 described below.

When it is judged that the delay necessity flag is not “necessary” at Step S35 (Step S35; NO), it is judged whether the p-th sheet and the (p+1)-th sheet can be superposed or not (Step S38). More specifically, Step S38 is judged based on the conditions for sheet superposing (1) to (5).

When it is judged that the p-th sheet and the (p+1)-th sheet cannot be superposed at Step S38 (Step S38; NO), the delay necessity flag is set to “necessary” (Step S39). Then, the number of sheets to be superposed for the p-th sheet is set to “one sheet” (Step S40). More specifically, “1” is set to the superposed-sheet number for the p-th sheet in the sheet information table. Then, “p” is set to “p+1” (Step S41). After Step S41, the processing moves to Step S34.

When it is judged that the p-th sheet and the (p+1)-th sheet can be superposed at Step S38 (Step S38; YES), it is judged whether the p-th to (p+2)-th sheets can be superposed or not (Step S42). More specifically, Step S42 is judged based on the conditions for sheet superposing (1) to (5).

When it is judged that the p-th to (p+2)-th sheets cannot be superposed at Step S42 (Step S42; NO), the number of sheets to be superposed for the p-th sheet is set to “two sheets” (Step S43). More specifically, “2” is set to the superposed-sheet number for the p-th sheet in the sheet information table. Then, “p” is set to “p+2” (Step S44). After Step S44, the processing moves to Step S34.

When it is judged that the p-th to (p+2)-th sheets can be superposed at Step S42 (Step S42; YES), it is judged whether the (p+2)-th sheet and the (p+3)-th sheet can be superposed or not (Step S45). More specifically, Step S45 is judged based on the conditions for sheet superposing (1) to (5).

When it is judged that the (p+2)-th sheet and the (p+3)-th sheet can be superposed at Step S45 (Step S45; YES), the processing moves to Step S43. When it is judged that the (p+2)-th sheet and the (p+3)-th sheet cannot be superposed at Step S45 (Step S45; NO), the number of sheets to be superposed for the p-th sheet is set to “three sheets” (Step S46). More specifically, “3” is set to the superposed-sheet number for the p-th sheet in the sheet information table. Then, “p” is set to “p+3” (Step S47). After Step S47, the processing moves to Step S34.

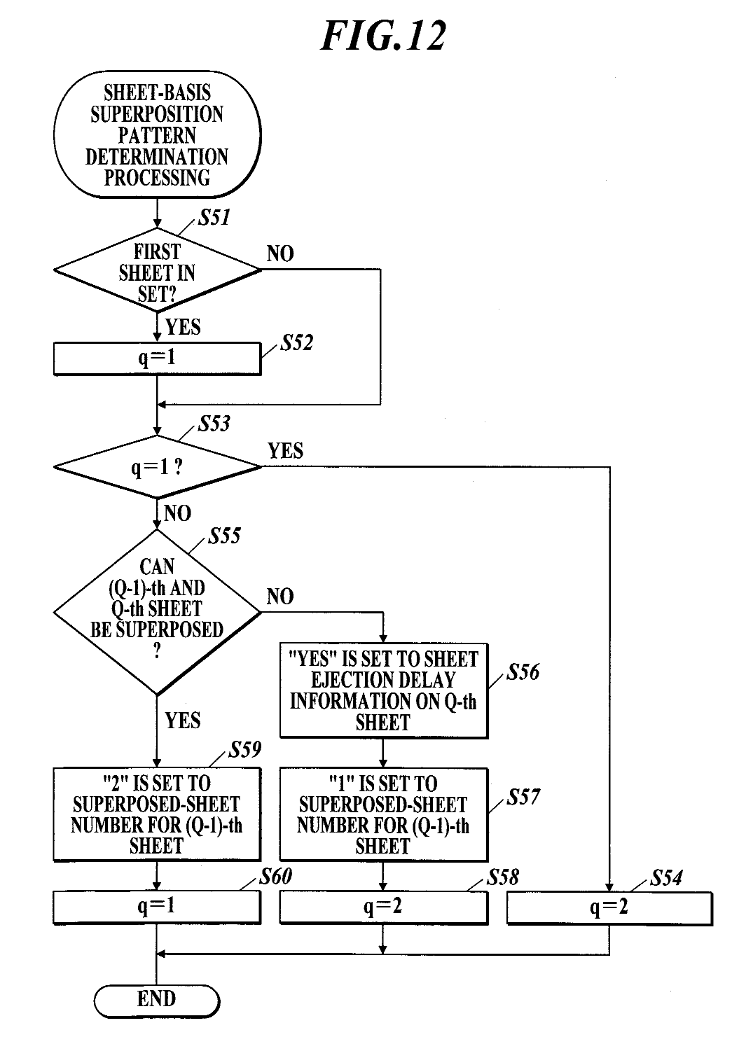

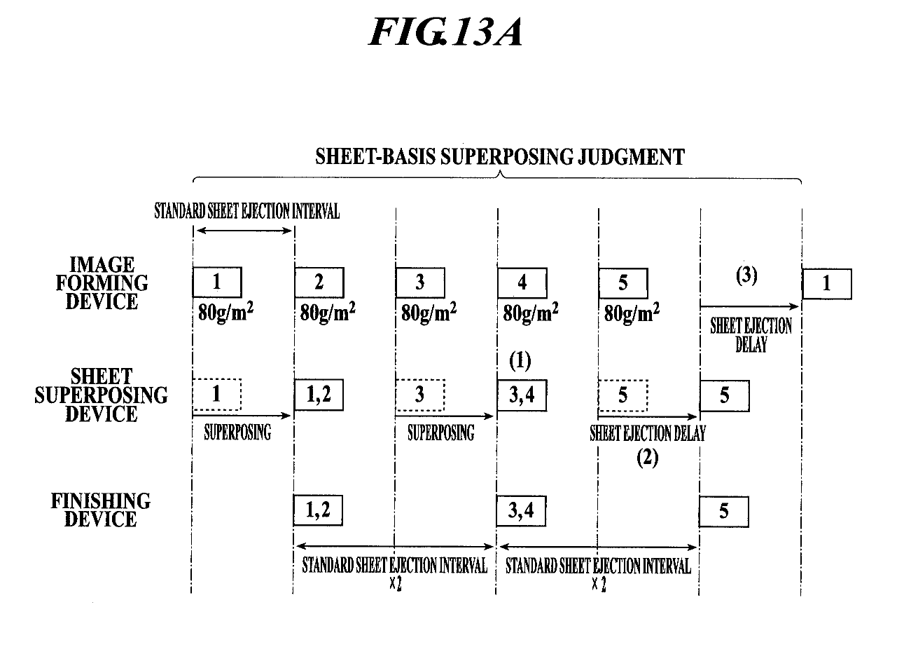

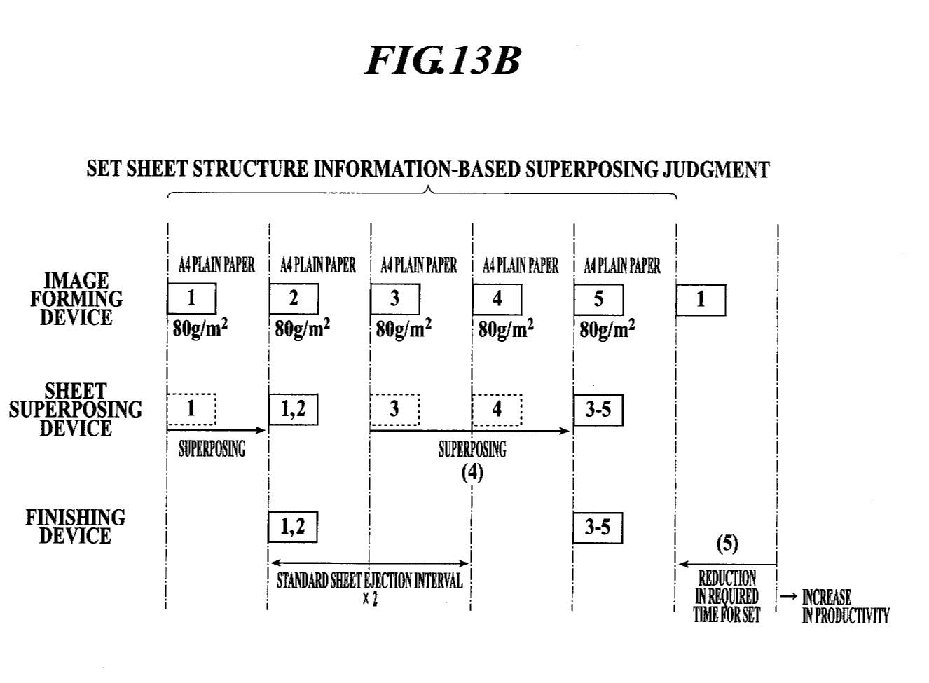

Next, the sheet-basis superposition pattern determination processing performed at Step S30 in the superposition pattern determination processing is described referring to FIG. 12. The sheet-basis superposition pattern determination processing is processing by which a superposition pattern is determined based on sheet information on each sheet.

First, it is judged whether a sheet is the first sheet in a set or not (Step S51). More specifically, Step S51 is judged based on whether sheet information on the first sheet is received from the image forming device 1 right after a job start signal is received or not, or whether sheet information is received from the image forming device 1 right after a set break signal is received or not.

When it is judged that the sheet is not the first sheet in a set at Step S51 (Step S51; NO), the processing moves to Step S53 described below. When it is judged that the sheet is the first sheet in a set at Step S51 (Step S51; YES), “q” is set to “1” (Step S52). The “q” is a value indicating what number a sheet is among sheets which are superposed. For example, when three sheets which are the fourth, the fifth, and the sixth sheets of a set are superposed, “q” for the fourth sheet is “1”, “q” for the fifth sheet is “2”, and “q” for the sixth sheet is “3”.

After Step S52, it is judged whether “q” is “1” or not (Step S53). When it is judged that “q” is “1” at Step S53 (Step S53; YES), “q” is set to “2” (Step S54). After Step S54, the sheet-basis superposition pattern determination processing ends.

When it is judged that “q” is not “1” at Step S53 (Step S53; NO), it is judged whether the (q−1)-th sheet and the q-th sheet can be superposed or not (Step S55). More specifically, Step S55 is judged based on the conditions for sheet superposing (1) to (6). In this processing, superposition of three sheets requires performing the processing based on a sheet condition of a sheet which is two sheets ahead of the present sheet, which makes the processing complicated. Therefore, Step S55 is judged based on the conditions for sheet superposing including the condition (6) “not more than two sheets are superposed regardless of the basis weight”.

When it is judged that the (q−1)-th sheet and the q-th sheet cannot be superposed at Step S55 (Step S55; NO), “YES” is set to the sheet ejection delay information on the q-th sheet (Step S56). Namely, “YES” is set to the sheet ejection delay information on the q-th sheet in the sheet information table. Then, the number of sheets to be superposed for the (q−1)-th sheet is set to “one sheet” (Step S57). More specifically, “1” is set to the superposed-sheet number for the (q−1)-th sheet in the sheet information table. After Step S57, “q” is set to “2” (Step S58). After Step S58, the sheet-basis superposition pattern determination processing ends.

When it is judged that the (q−1)-th sheet and the q-th sheet can be superposed at Step S55 (Step S55; YES), the number of sheets to be superposed for the (q−1)-th sheet is set to “two sheets” (Step S59). More specifically, “2” is set to the superposed-sheet number for the (q−1)-th sheet in the sheet information table. After Step S59, “q” is set to “1” (Step S60). After Step S60, the sheet-basis superposition pattern determination processing ends.

As described above, according to the embodiment of the present invention, when the number of sheets in a set is two or more, two sheets or more of the set are superposed by the sheet superposing device 2 unless it is impossible. For example, as shown in FIGS. 6A to 8B, when it is judged that the number of sheets in the first set is two or more, the sheet superposing device 2 performs processing for the second set, the processing by which two sheets or more of the second set are superposed. As a result, the operation to eject only one sheet (eject only the fifth sheet as shown in FIG. 6A, for example) is prevented from being performed as much as possible. Namely, the processing time for each set can be reduced, and the productivity can be increased accordingly.

Moreover, the sheet superposing device 2 determines a superposition pattern and a sheet ejection timing based onset sheet structure information when the sheet superposing device 2 receives and obtains (stores in RAM 253) set sheet structure information from the image forming device 1. As a result, the processing time for each set can be reduced, and the productivity can be increased accordingly.

Furthermore, the sheet superposing device 2 determines a superposition pattern and a sheet ejection timing based on sheet information on each sheet when set sheet structure information is not obtained (not finalized). As a result, sheet superposing according to the circumstances can be performed.

The image forming system 100 of the present invention is not limited to the embodiment described above, and hence the detailed structure and operation of the image forming system 100 can be appropriately modified without departing from the scope of the present invention.

According to a first aspect of the embodiment of the present invention, there is provided a sheet superposing device to superpose sheets supplied from an image forming device, and eject the superposed sheets to a finishing device following the sheet superposing device, the sheet superposing device including: a control section to obtain sheet structure information indicating a structure of sheets of a set, the set on which finishing is performed; judge whether or not a number of the sheets of the set is two or more based on the obtained sheet structure information; and superpose two sheets or more of the sheets of the set when the number of the sheets of the set is two or more.

According to a second aspect of the embodiment of the present invention, there is provided an image forming system including: an image forming device to form an image on a sheet; the sheet superposing device to superpose sheets, on each of which an image is formed by the image forming device; and a finishing device to receive the sheets superposed by the sheet superposing device, and perform finishing on the superposed sheets.

Accordingly, the productivity can be increased by reducing processing time for each set of sheets.

Preferably, the sheet superposing device further includes a communication section to communicate with the image forming device, wherein the control section judges whether the sheet structure information is obtained or not based on whether the sheet structure information is received via the communication section or not, and determines, based on the sheet structure information, a superposition pattern of the sheets of the set and a supply timing at which each of the sheets is supplied from the image forming device when the control section judges that the sheet structure information is obtained.

Preferably, in the sheet superposing device, the control section determines the superposition pattern and the supply timing based on sheet information on each of the sheets when the control section judges that the sheet structure information is not obtained.

Preferably, in the sheet superposing device, the sheet structure information includes at least one of: the number of the sheets of the set; a sheet number in the set; a type of finishing performed by the finishing device; a size; a paper type; a basis weight; last sheet information indicating that a sheet is a last sheet in the set or not; delay information indicating that delaying a supply timing at which a sheet is supplied from the image forming device is necessary or not; and a superposed-sheet number information indicating a number of sheets to be superposed, with regard to each of the sheets of the set.

The present U.S. patent application claims priority from Japanese Patent Application No. 2009-238915 filed with Japan Patent Office on Oct. 16, 2009, under the Paris Convention for the Protection of Industrial Property, and the Japanese Patent Application is a ground for correction of mistakes in translation of the present U.S. patent application.

What is claimed is:

1. A sheet superposing device to superpose sheets supplied from an image forming device, and eject the superposed sheets to a finishing device following the sheet superposing device, the sheet superposing device comprising:
a control section to obtain sheet structure information indicating a structure of sheets of a set, the set on which finishing is performed; judge whether or not a number of the sheets of the set is two or more based on the obtained sheet structure information; and superpose two sheets or more of the sheets of the set when the number of the sheets of the set is two or more.

2. The sheet superposing device according to claim 1 further comprising:
a communication section to communicate with the image forming device, wherein
the control section judges whether the sheet structure information is obtained or not based on whether the sheet structure information is received via the communication section or not, and determines, based on the sheet structure information, a superposition pattern of the sheets of the set and a supply timing at which each of the sheets is supplied from the image forming device when the control section judges that the sheet structure information is obtained.

3. The sheet superposing device according to claim 2, wherein the control section determines the superposition pattern and the supply timing based on sheet information on each of the sheets when the control section judges that the sheet structure information is not obtained.

4. The sheet superposing device according to claim 1, wherein the sheet structure information includes at least one of: the number of the sheets of the set; a sheet number in the set; a type of finishing performed by the finishing device; a size; a paper type; a basis weight; last sheet information indicating that a sheet is a last sheet in the set or not; delay information indicating that delaying a supply timing at which a sheet is supplied from the image forming device is necessary or not; and a superposed-sheet number information indicating a number of sheets to be superposed, with regard to each of the sheets of the set.

5. An image forming system comprising:
an image forming device to form an image on a sheet;
the sheet superposing device according to claim 1, the sheet superposing device to superpose sheets, on each of which an image is formed by the image forming device; and
a finishing device to receive the sheets superposed by the sheet superposing device, and perform finishing on the superposed sheets.
